(19) United States
(12) Patent Application Publication
(10) Pub. No.: US 2026/0126405 A1
(43) Pub. Date: May 7, 2026

(54) ELECTRONIC DEVICE AND METHOD OF MEASURING INTRACELLULAR SIGNAL

(71) Applicant: SAMSUNG ELECTRONICS CO., LTD., Suwon-si (KR)

(72) Inventor: Byungsu JUNG, Suwon-Si (KR)

(73) Assignee: SAMSUNG ELECTRONICS CO., LTD., Suwon-si (KR)

(21) Appl. No.: 19/247,281

(22) Filed: Jun. 24, 2025

(30) Foreign Application Priority Data
Nov. 7, 2024 (KR) 10-2024-0157390

(51) Int. Cl. G01N 27/02

(52) U.S. Cl. CPC G01N 27/028

(57) ABSTRACT

An electronic device includes an electrode configured to contact a cell, a power supply device connected to the electrode and configured to apply a current to the cell, an amplifier circuit configured to measure at least one component of the current, a processor, and a memory storing instructions, where the instructions, when executed by the processor, cause the electronic device to measure an impedance between the cell and the electrode based on the current, and determine a connection strength between the cell and the electrode based on the impedance.

### CROSS-REFERENCE TO RELATED APPLICATION

This application is based on and claims priority to Korean Patent Application No. 10-2024-0157390, filed on Nov. 7, 2024, in the Korean Intellectual Property Office, the disclosure of which is incorporated herein by reference in its entirety.

### BACKGROUND

### 1. Field

The disclosure relates to an electronic device and a method of measuring an intracellular signal.

### 2. Description of Related Art

To measure intracellular signals, circuits for signal measurement and cells may be connected by electrical and/or physical methods. For example, to measure intracellular signals through a multielectrode array (MEA), cells may be electrically connected to the MEA. In another example, to measure intracellular signals through a patch clamp, cells may be physically connected to the patch clamp.

Information in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

Additional aspects will be set forth in part in the description which follows and, in part, will be apparent from the description, or may be learned by practice of the presented embodiments of the disclosure.

According to an aspect of the disclosure, an electronic device may include an electrode configured to contact a cell, a power supply device connected to the electrode and configured to apply a current to the cell, an amplifier circuit configured to measure at least one component of the current, a processor, and a memory storing instructions, where the instructions, when executed by the processor, cause the electronic device to measure an impedance between the cell and the electrode based on the current, and determine a connection strength between the cell and the electrode based on the impedance.

The power supply device may include a first power supply device configured to apply a direct current (DC) to the cell and a second power supply device configured to apply an alternating current (AC) to the cell.

The at least one component of the current may include a DC component and an AC component, and the amplifier circuit may include a first amplifier circuit configured to measure the DC component of the current and a second amplifier circuit configured to measure the AC component of the current.

The instructions, when executed by the processor, may further cause the electronic device to measure, through the first amplifier circuit, a DC voltage of the electrode generated by the DC applied by the first power supply device to the cell, and the instructions, when executed by the processor, may cause the electronic device to measure the impedance by measuring, based on the measured DC voltage, a first impedance of the DC component generated by applying the DC to the cell.

The instructions, when executed by the processor, may further cause the electronic device to measure, through the second amplifier circuit, the AC applied by the second power supply device to the cell, and the instructions, when executed by the processor, may cause the electronic device to measure the impedance by measuring, based on the measured AC, a second impedance of the AC component generated by applying the AC.

The instructions, when executed by the processor, may cause the electronic device to determine the connection strength by, based on the impedance being greater than a preset threshold value, determining that the connection strength between the cell and the electrode is strong, and based on the impedance is smaller than the preset threshold value, determining that the connection strength between the cell and the electrode is weak, and the instructions, when executed by the processor, may further cause the electronic device to increase an intensity of the current applied to the cell based on the connection strength being determined to be weak.

The instructions, when executed by the processor, may further cause the electronic device to adjust an intensity of the current based on the connection strength between the cell and the electrode.

The instructions, when executed by the processor, may cause the electronic device to adjust the intensity of the current by increasing the intensity of the current based on the connection strength between the cell and the electrode being determined to be weak.

According to an aspect of the disclosure, a method of operating an electronic device may include applying at least one component of a current to a cell that contacts an electrode, measuring an impedance between the cell and the electrode based on the current, and determining a connection strength between the cell and the electrode based on the impedance.

The at least one component of the current may include a DC component and an AC component.

The measuring of the impedance between the cell and the electrode may include measuring at least one of the DC component and the AC component.

The measuring of the impedance between the cell and the electrode may include measuring a DC voltage of the electrode generated by a DC applied to the cell, and measuring, based on the measured DC voltage, a first impedance of the DC component generated by applying the DC to the cell.

The measuring of the impedance between the cell and the electrode may include measuring an AC applied to the cell, and measuring, based on the measured AC, a second impedance of the AC component generated by applying the AC to the cell.

The determining of the connection strength between the cell and the electrode may include, based on the impedance being greater than a preset threshold value, determining that the connection strength between the cell and the electrode is strong, and based on the impedance being smaller than the preset threshold value, determining that the connection strength between the cell and the electrode is weak, and the method may include increasing an intensity of the current applied to the cell based on the connection strength being determined to be weak.

The method may include adjusting an intensity of the current based on the connection strength between the cell and the electrode.

The adjusting of the intensity of the current may include increasing the intensity of the current based on the connection strength between the cell and the electrode being determined to be weak.

According to an aspect of the disclosure, a non-transitory, computer-readable storage medium may store instructions that, when executed by at least one processor, cause an intracellular signal measurement device to apply at least one component of a current to a cell that contacts an electrode, measure an impedance between the cell and the electrode based on the current, determine a connection strength between the cell and the electrode based on the impedance, and increase an intensity of the current applied to the cell based on the connection strength being determined to be weak.

The at least one component of the current may include a DC component and an AC component, and the instructions, when executed by the at least one processor, may cause the intracellular signal measurement device to measure the impedance between the cell and the electrode by measuring at least one of the DC component and the AC component.

The instructions, when executed by the at least one processor, may cause the intracellular signal measurement device to measure the impedance between the cell and the electrode by measuring a DC voltage of the electrode generated by a DC applied to the cell, and measuring, based on the measured DC voltage, a first impedance of the DC component generated by applying the DC to the cell.

The instructions, when executed by the at least one processor, may cause the intracellular signal measurement device to measure the impedance between the cell and the electrode by measuring an AC applied to the cell, and measuring, based on the measured AC, a second impedance of the AC component generated by applying the AC to the cell.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1A is a diagram illustrating an intracellular signal measurement system according to one or more embodiments;

FIG. 1B is a diagram illustrating a multielectrode array (MEA) according to one or more embodiments;

FIG. 2 is a diagram illustrating an intracellular signal measurement device shown in FIG. 1A, according to one or more embodiments;

FIG. 3 is a flowchart illustrating a method of measuring a first impedance generated by applying a direct current (DC) according to one or more embodiments;

FIG. 4 is a flowchart illustrating a method of measuring a first impedance generated by applying an alternating current (AC) according to one or more embodiments;

FIG. 5 is a flowchart illustrating an intracellular signal measurement method according to one or more embodiments; and

FIG. 6 is a diagram illustrating an electronic device according to one or more embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereinafter, will be described in detail with reference to the attached drawings. In the drawings, like reference numerals refer to like elements throughout and sizes of constituent elements may be exaggerated for convenience of explanation and the clarity of the specification. Also, embodiments described herein may have different forms and should not be construed as being limited to the descriptions set forth herein.

Terms, such as first, second, and the like, may be used herein to describe various components. Each of these terminologies is not used to define an essence, order or sequence of a corresponding component but used merely to distinguish the corresponding component from other component(s). For example, a first component may be referred to as a second component, or similarly, the second component may be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The use of the terms “a” and “an” and “the” and similar referents are to be construed to cover both the singular and the plural. The steps of all methods described herein can be performed in any suitable order unless otherwise indicated herein or otherwise clearly contradicted by context, and are not limited to the described order.

It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device.

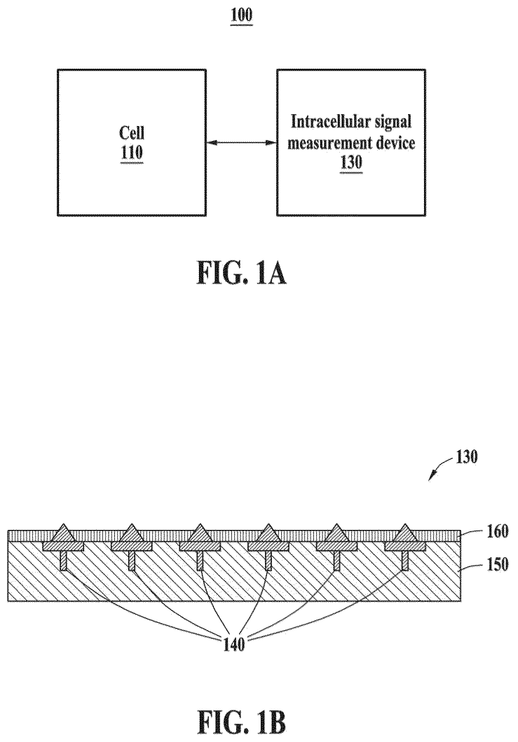

FIG. 1A is a diagram illustrating an intracellular signal measurement system according to one or more embodiments.

Referring to FIG. 1A, according to one or more embodiments, an intracellular signal measurement system 100 may include a cell 110 and an intracellular signal measurement device 130.

According to one or more embodiments, the cell 110 may include, but is not limited to, cells of neural network tissue, organ tissue, or the like, and may include cells capable of measuring electrical signals. The cell 110 may include, but is not limited to, human or animal cells, and may include cells that may be cultured to measure electrical signals.

According to one or more embodiments, the cell 110 may be cultured in a culture vessel. For example, the cell 110 may be contained in a culture vessel, and a medium for culturing the cell 110 may be supplied to the culture vessel. Culturing the cell 110 may require a long period of time, and therefore, the cell 110 may be cultured in a state separated from the intracellular signal measurement device 130, and may be electrically connected to the intracellular signal measurement device 130 when measuring an intracellular signal of the cell 110.

According to one or more embodiments, the intracellular signal measurement device 130 may be implemented as a multielectrode array (MEA). The MEA is an array of a plurality of electrodes (e.g., microelectrodes) that may be used to measure an intracellular signal in the cell 110 or stimulate the cell 110. A specific configuration of the MEA is described in detail with reference to FIG. 1B.

According to one or more embodiments, the intracellular signal measurement device 130 may be electrically connected to the cell 110. The intracellular signal measurement device 130 may be connected to the cell 110 by applying electrical stimulation to the cell 110. For example, the intracellular signal measurement device 130 may apply a current (e.g., direct current (DC)) to the cell 110. When the current is applied to the cell 110, the cell 110 and the intracellular signal measurement device 130 may be connected to each other.

According to one or more embodiments, the intracellular signal measurement device 130 may measure a connection strength (or a connection state) between the cell 110 and the intracellular signal measurement device 130. When the connection strength between the cell 110 and the intracellular signal measurement device 130 is low, the intracellular signal measurement device 130 may increase the connection strength by applying strong electrical stimulation (e.g., increasing an intensity of the current applied to the cell 110). However, if the electrical stimulation is applied too strongly, the cell 110 may be destroyed, and therefore, an upper limit of the electrical stimulation may be set.

FIG. 1B is a diagram illustrating an MEA according to one or more embodiments.

Referring to FIG. 1B, the intracellular signal measurement device 130 according to one or more embodiments may include a plurality of electrodes 140, an integrated circuit 150, and a passivation layer 160.

According to one or more embodiments, the passivation layer 160 may be formed on one side surface of the integrated circuit 150. For example, the passivation layer 160 may be coated on the one side surface of the integrated circuit 150. For example, the passivation layer 160 may prevent corrosion of the integrated circuit 150 or prevent the surrounding environment from affecting the integrated circuit 150.

According to one or more embodiments, the plurality of electrodes 140 may be formed on one side of the integrated circuit 150 according to a pattern. For example, as shown in FIG. 1B, the plurality of electrodes 140 may penetrate the coated passivation layer 160 so that the one side thereof may be exposed to the outside. The other side of the plurality of electrodes 140 may be connected to the integrated circuit 150. For example, the plurality of electrodes 140 may be formed according to a grid-like pattern with set intervals. The pattern of the plurality of electrodes 140 may be set variously.

According to one or more embodiments, the plurality of electrodes 140 may receive electrical signals or transmit electrical signals. For example, when the intracellular signal measurement device 130 is coupled to a culture vessel (e.g., a vessel in which the cell 110 is cultured), the plurality of electrodes 140 may receive or transmit electrical signals through a conductive material of the culture vessel.

According to one or more embodiments, the integrated circuit 150 may amplify the electrical signals received from the plurality of electrodes 140, and transmit the electrical signals to a device (e.g., a memory and/or a processor) connected to the integrated circuit 150 to process the electrical signals. The integrated circuit 150 may include a plurality of components (e.g., a power supply device, a capacitor, an amplifier circuit, an analog-to-digital converter (ADC), etc.) for performing the above operations.

According to one or more embodiments, the device for processing electrical signals may identify the electrical signals received from the respective electrodes. The device for processing the electrical signals may process electrical signals received from the respective electrodes, and analyze a connection state and a connection strength between the electronic device and the cell 110 for each electrode.

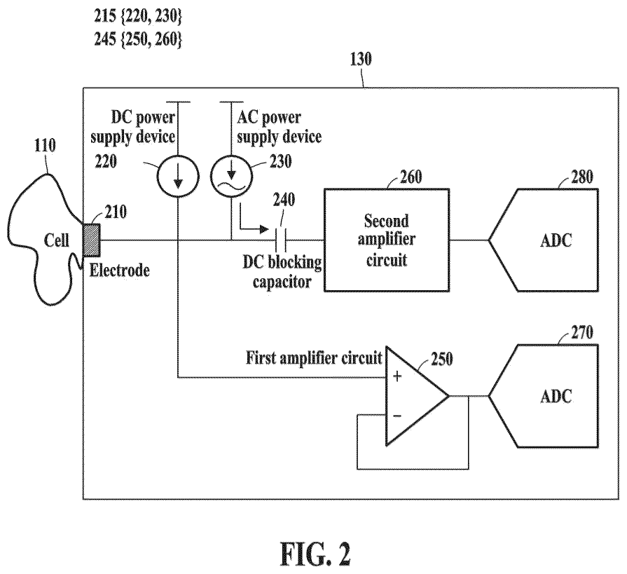

Hereinafter, the configuration of the intracellular signal measurement device 130 for measuring the connection strength between the cell 110 and the intracellular signal measurement device 130 will be described in detail with reference to FIG. 2.

FIG. 2 is a diagram illustrating an intracellular signal measurement device shown in FIG. 1A, according to one or more embodiments.

Referring to FIG. 2, according to one or more embodiments, the intracellular signal measurement device 130 may include an electrode 210 (e.g., at least one of the plurality of electrodes 140 of FIG. 1B), a power supply device 215 (e.g., a DC power supply device 220 and/or an alternating current (AC) power supply device 230), a DC blocking capacitor 240, an amplifier circuit 245 (e.g., a first amplifier circuit 250 and/or a second amplifier circuit 260), a first ADC 270 and a second ADC 280.

According to one or more embodiments, the components shown in FIG. 2 (e.g., the power supply device 215, the DC blocking capacitor 240, the amplifier circuit 245, and the ADCs 270 and 280) may be included in the integrated circuit 150 of FIG. 1B.

According to one or more embodiments, the intracellular signal measurement device 130 may be implemented as an MEA, and may include a plurality of electrodes, as described above with reference to FIG. 1B. When the intracellular signal measurement device 130 includes the plurality of electrodes, the components shown in FIG. 2 may be configured for each electrode to perform operations to be described below substantially identically. Hereinafter, for convenience of description, a case where the intracellular signal measurement device 130 includes only one electrode will be described.

According to one or more embodiments, the electrode 210 may contact the cell 110, and transmit and receive an electrical signal from the cell 110. For example, when the cell 110 is contained in a culture vessel, the electrode 210 may receive an electrical signal from the cell 110 or transmit an electrical signal to the cell 110 through a conductive material of the culture vessel.

According to one or more embodiments, the power supply device 215 may be electrically connected to the electrode 210 to apply an electrical signal (e.g., a current and/or a voltage) to the cell 110. The power supply device 215 may include the DC power supply device 220 and the AC power supply device 230. The DC power supply device 220 may apply a DC (and/or a DC voltage) to the cell 110, and the AC power supply device 230 may apply an AC (and/or an AC voltage) to the cell 110.

According to one or more embodiments, when the DC is applied to the cell 110 from the DC power supply device 220, the cell 110 may be electrically connected to the electrode 210. When the cell 110 is electrically connected to the electrode 210, the intracellular signal measurement of the cell 110 may be possible. In order to maintain a state in which the intracellular signal measurement of the cell 110 is possible, the DC may need to be continuously applied to the cell 110 from the DC power supply device 220.

According to one or more embodiments, the amplifier circuit 245 may measure an electrical signal (e.g., a current and/or a voltage) applied from the power supply device 215. The amplifier circuit 245 may measure both the DC component (and/or a DC voltage) and the AC component (and/or an AC voltage) together when both the DC and AC are applied simultaneously. The first amplifier circuit 250 may measure the DC component (and/or a DC voltage), and the second amplifier circuit 260 may measure the AC component (and/or an AC voltage). This will be described in detail below.

According to one or more embodiments, the first amplifier circuit 250 may measure a DC voltage according to the DC applied from the DC power supply device 220. Since a resistance of a first path (e.g., a path from the DC power supply device 220 to the first amplifier circuit 250) is not zero, a voltage drop may occur according to Ohm's law when the DC flows through the first path. This voltage drop occurs at both ends of the electrode 210 so that the DC voltage of the electrode 210 may be generated by the DC. The DC voltage of the electrode 210 may be provided as an input of the first amplifier circuit 250. Since the first amplifier circuit 250 directly transfers an input signal (e.g., a DC voltage of the electrode 210) as an output, the output of the first amplifier circuit 250 may be the same as the voltage of the electrode 210 (e.g., the voltage generated at both ends of the electrode 210).

According to one or more embodiments, the first amplifier circuit 250 may include a voltage follower. The voltage follower may be an amplifier circuit that minimizes a load on the circuit with a very high input impedance and a very low output impedance while transferring an input signal as an output as it is. For example, the voltage follower may obtain an input signal with little effect on a voltage generated at both ends of a sensing resistor according to the very high input impedance. Additionally, since the voltage follower has a very low output impedance, a signal loss may be minimized when transmitting a signal to a next stage device (e.g. the first ADC 270).

According to one or more embodiments, the second amplifier circuit 260 may measure the AC applied from the AC power supply device 230. A current transformer (or a sensing resistor) may be connected in series in a second path (e.g., a path from the AC power supply device 230 to the second amplifier circuit 260) through which the AC flows. When the AC flows through the second path, it may be transformed through the current transformer. The second amplifier circuit 260 may receive and amplify an output of the current transformer (e.g., a transformed AC) (e.g., a voltage generated at both ends of the sensing resistor when the sensing resistor is connected in series) to measure the AC.

According to one or more embodiments, the DC blocking capacitor 240 may block a DC component of the current flowing to the second amplifier circuit 260 through the second path. For example, in a situation where the DC power supply device 220 is turned off and the AC power supply device 230 is turned on, the current flowing to the second amplifier circuit 260 through the second path may not have the DC component. However, in a situation where both the DC power supply device 220 and the AC power supply device 230 are turned on, the current flowing through the second path may include the DC component (e.g., the DC applied by the DC power supply device 220) in addition to the AC component (e.g., the AC applied by the AC power supply device 230). In this case, the DC component of the current (e.g. the DC) may need to be blocked to measure only the AC. The DC blocking capacitor 240 may block the DC component of the current flowing through the second path, allowing only AC to flow to the second amplifier circuit 260.

According to one or more embodiments, the first ADC 270 and the second ADC 280 may change an output (e.g., an analog signal) of the amplifier circuit (e.g., the first amplifier circuit 250 and/or the second amplifier circuit 260) into a digital signal. For example, the first ADC 270 may change the output of the first amplifier circuit 250 (e.g., the DC voltage of the electrode 210) into a digital signal. The first ADC 270 may transmit the digital signal to a device (e.g., a memory and/or a processor) for processing electrical signals. The device for processing electrical signals may measure the impedance between the electrode 210 and the cell 110 based on the digital signal, and determine the connection strength between the electrode 210 and the cell 110 according to the impedance. Hereinafter, the signal processed by the intracellular signal measurement device 130 may be a digital signal converted through the ADCs 270 and 280.

According to one or more embodiments, an impedance may be present between the electrode 210 and the cell 110. The impedance between the electrode 210 and the cell 110 may include a first impedance generated by applying the DC, a second impedance generated by applying the AC, and an input impedance of a circuit itself (e.g., the integrated circuit 150 of FIG. 1B). The first impedance may be measured through the DC voltage of the electrode 210. The second impedance and the input impedance of the circuit itself may be measured through the AC. The first impedance may be an impedance of the DC component. The second impedance and the input impedance of the circuit itself are the impedances of the AC component, which may cause the following problems during measurement.

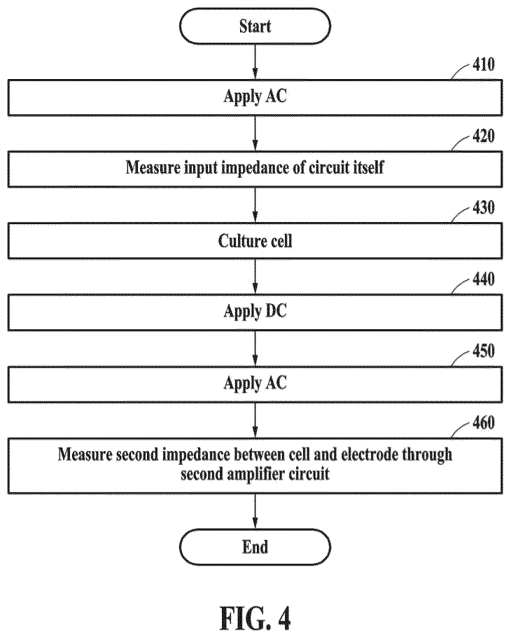

According to one or more embodiments, when the AC is applied to the cell 110 by the AC power supply device 230, the intracellular signal measurement device 130 may measure the AC through the second amplifier circuit 260. The intracellular signal measurement device 130 may measure the impedance of the AC component between the electrode 210 and the cell 110 with the AC measured through the second amplifier circuit 260. The components of the measured impedance of the AC component may be different based on whether the cell 110 is connected to the electrode 210. For example, when the cell 110 is connected to the electrode 210 (e.g., in a state where the DC is applied by the DC power supply device 220), the measured impedance of the AC component may include the second impedance and the input impedance of the circuit itself. On the other hand, when the cell 110 is not connected to the electrode 210 (e.g., in a state where the DC is not applied by the DC power supply device 220), the measured impedance of the AC component may include only the input impedance of the circuit itself. Therefore, in order to measure the second impedance, it may be required to remove the input impedance of the circuit itself from the measured impedance of the AC component while the cell 110 is connected to the electrode 210. This will be described in detail with reference to FIG. 4.

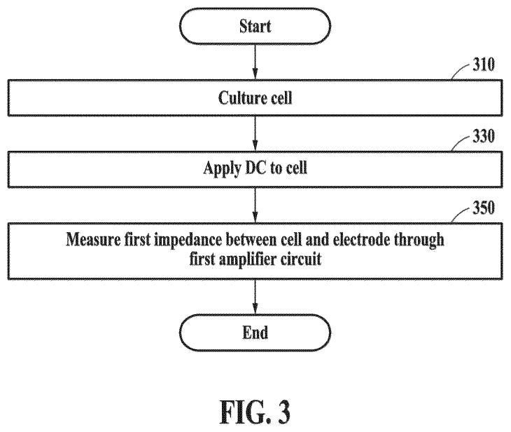

FIG. 3 is a flowchart illustrating a method of measuring a first impedance generated by applying a DC according to one or more embodiments.

Referring to FIG. 3, according to one or more embodiments, operations 310 to 350 may be performed sequentially, but not be necessarily performed sequentially. For example, the order of operations 310 to 350 may be changed, and at least two of operations 310 to 350 may be performed in parallel.

In operation 310, a cell (e.g., the cell 110 of FIG. 1A) may be cultured. A long period of time may be required to culture the cell 110. The cell 110 may be cultured in a state separated from an intracellular signal measurement device (e.g., the intracellular signal measurement device 130 of FIG. 1A) (e.g., in a state contained in a culture vessel separated from the intracellular signal measurement device 130). The cell 110 may be cultured in a separated state in the intracellular signal measurement device 130, and when an electrical signal is measured, the cell 110 may be attached to the intracellular signal measurement device 130 to measure an electrical signal with high throughput.

In operation 330, the intracellular signal measurement device 130 may apply the DC to the cell 110. The DC power supply device (e.g., the DC power supply device 220 of FIG. 2) may apply the DC to an electrode (e.g., the electrode 210 of FIG. 2) contacting the cell 110. The DC may be transmitted to the cell 110 through the electrode 210. As the DC is applied to the cell 110, the cell 110 may be connected to the electrode 210 so as to perform the intracellular signal measurement for the cell 110.

In operation 350, the intracellular signal measurement device 130 may measure the first impedance between the cell 110 and the electrode 210 through a first amplifier circuit (e.g., the first amplifier circuit 250 of FIG. 2).

According to one or more embodiments, the intracellular signal measurement device 130 may measure the DC voltage of the electrode 210 generated by the DC through the first amplifier circuit 250. This has been described above in detail with reference to FIG. 2, and thus any repeated description is omitted.

According to one or more embodiments, the intracellular signal measurement device 130 may measure the first impedance of the DC component generated by applying the DC, based on the DC voltage. The intracellular signal measurement device 130 may measure the first impedance between the cell 110 and the electrode 210 by dividing the DC voltage by the DC (e.g., the DC is a user-set value and does not require separate measurement) according to Ohm's law.

FIG. 4 is a flowchart illustrating a method of measuring a first impedance generated by applying an AC according to one or more embodiments.

Referring to FIG. 4, according to one or more embodiments, operations 410 to 460 may be performed sequentially, but are not necessarily performed sequentially. For example, the order of operations 410 to 460 may be changed, and at least two of operations 410 to 460 may be performed in parallel.

In operation 410, an intracellular signal measurement device (e.g., the intracellular signal measurement device 130 of FIG. 1A) may apply an AC to a cell (e.g., the cell 110 of FIG. 1A). An AC power supply device (e.g., the AC power supply device 230 of FIG. 2) may apply the AC to an electrode (e.g., the electrode 210 of FIG. 2) contacting the cell 110. The AC may be transmitted to the cell 110 through the electrode 210. However, since only the AC is applied to the cell 110 and no DC is applied, the cell 110 may not be connected to the electrode 210, and the intercellular signal measurement for the cell 110 may be impossible.

In operation 420, the intracellular signal measurement device 130 may measure an input impedance (e.g., an impedance by the circuit alone without the influence of the cell 110, in a state where the intercellular signal measurement for the cell 110 is impossible) of a circuit (e.g., the integrated circuit 150 of FIG. 1B) itself. The intracellular signal measurement device 130 may measure the AC through a second amplifier circuit (e.g., the second amplifier circuit 260 of FIG. 2). The intracellular signal measurement device 130 may measure an impedance of the AC component based on the AC. The impedance of the AC component measured at this time is measured in a state where only the AC is applied (e.g., a state where the cell 110 is not connected to the electrode 210), and may only include the input impedance of the circuit itself.

According to one or more embodiments, the intracellular signal measurement device 130 may turn the AC power supply device 230 off after measuring the input impedance of the circuit itself.

In operation 430, the cell may be cultured. Operation 430 is substantially the same as operation 310 of FIG. 3, and thus repeated descriptions may be omitted below.

In operation 440, the intracellular signal measurement device 130 may apply the DC for the connection to the cultured cell, after the cell is cultured. For example, a DC power supply (e.g., the DC power supply device 220 of FIG. 2) may apply the DC to an electrode (e.g., the electrode 210 of FIG. 2) contacting the cell 110.

In operation 450, the intracellular signal measurement device 130 may apply the AC by substantially the same method as in operation 410.

In operation 460, the intracellular signal measurement device 130 may measure the second impedance between the cell 110 and the electrode 210 through the second amplifier circuit 260. The intracellular signal measurement device 130 may measure the AC through the second amplifier circuit 260, and measure the impedance of the AC component between the cell 110 and the electrode 210 based on the measured AC. The impedance of the AC component is measured in a state where the cell 110 is connected to the electrode 210 by applying the DC in operation 440, and may include the second impedance and the input impedance of the circuit itself. The intracellular signal measurement device 130 may determine the second impedance by removing the input impedance of the circuit itself measured in operation 420 from the impedance of the AC component.

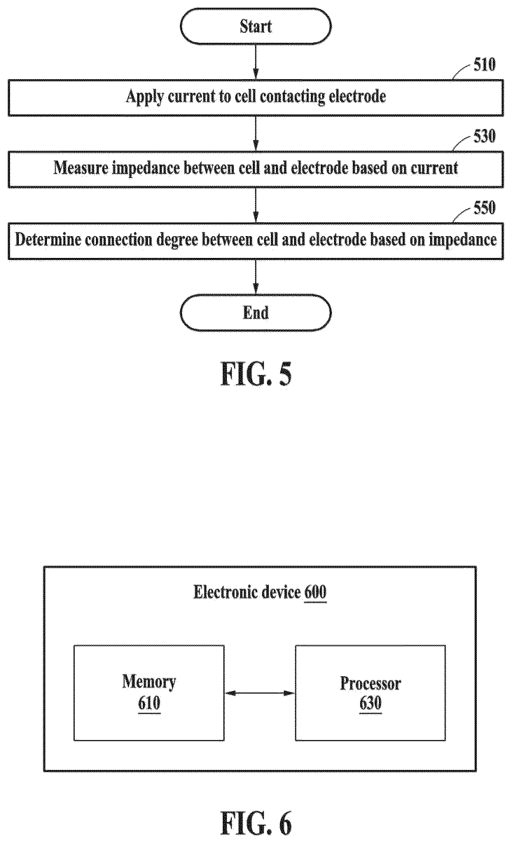

Referring to FIGS. 3 and 4, the method of measuring the impedance (e.g., the first impedance of the DC component and/or the second impedance of the AC component) between the cell 110 and the electrode 210 has been described. The intracellular signal measurement device 130 may determine the connection strength between the cell 110 and the electrode 210 based on the impedance between the cell 110 and the electrode 210, and adjust the current of the power supply device (e.g., the DC power supply device 220 and/or the AC power supply device 230) to maintain the connection strength high. This will be described in detail with reference to FIG. 5.

FIG. 5 is a flowchart illustrating an intracellular signal measurement method according to one or more embodiments.

Referring to FIG. 5, operations 510 to 550 may be performed sequentially, but are not necessarily performed sequentially. For example, the order of operations 510 to 550 may be changed, and at least two of operations 510 to 550 may be performed in parallel.

In operation 510, an intracellular signal measurement device (e.g., the intracellular signal measurement device 130 of FIG. 1A) may apply a current to a cell (e.g., the cell 110 of FIG. 1A) contacting an electrode (e.g., the electrode 210 of FIG. 2). For example, the intracellular signal measurement device 130 may apply a current (e.g., a DC and/or an AC) to the cell 110 through a power supply device (e.g., the DC power supply device 220 and/or the AC power supply device 230 of FIG. 2). In particular, when applying the DC, the cell 110 may be electrically connected to the electrode 210.

In operation 530, the intracellular signal measurement device 130 may measure an impedance (e.g., a first impedance of a DC component and/or a second impedance of an AC component) between the cell 110 and the electrode 210 based on the applied current. The method of measuring the first impedance has been described in detail with reference to FIG. 3, the method of measuring the second impedance has been described in detail with reference to FIG. 4, and thus any repeated description is omitted below.

In operation 550, the intracellular signal measurement device 130 may determine the connection strength between the cell 110 and the electrode 210 based on the impedance. When the impedance between the cell 110 and the electrode 210 is greater than a preset threshold value (e.g., set by a user or set by the intracellular signal measurement device 130), the intracellular signal measurement device 130 may determine that the connection strength between the cell 110 and the electrode 210 is strong. When the impedance between the cell 110 and the electrode 210 is smaller than the preset threshold value, the intracellular signal measurement device 130 may determine that the connection strength between the cell 110 and the electrode 210 is weak. For example, in a patch clamp setup for intracellular measurements, impedance may be assessed. Before cell approach (e.g., pipette in bath only), the impedance may be less than several tens of MOhm, after cell contact and gigaseal formation (e.g., membrane still intact), the impedance may be several GOhm, and upon whole-cell entry (e.g., membrane break-in), the impedance may be 10-30 MOhm While the threshold value may be user set or set by the intracellular signal measurement device 130, the threshold value may be determined based on the impedance levels mentioned above, and the threshold may be in the range of several GOhm. The impedance levels and threshold values may be determined based on typical ranges used in patch clamp techniques, and appropriate impedance levels may also be identified during each instance/experiment by confirming intracellular signals of acceptable quality.

According to one or more embodiments, the intracellular signal measurement device 130 may adjust an intensity of the current applied to the cell 110 based on the connection strength between the cell 110 and the electrode 210. As the intensity of the current applied to the cell 110 increases, the connection strength between the cell 110 and the electrode 210 may become stronger. However, when the intensity of the current applied to the cell 110 extremely increases and exceeds a specific reference value (e.g., an upper limit), the cell 110 may be destroyed. The intracellular signal measurement device 130 may maintain a strong connection strength between the cell 110 and the electrode 210. That is, when the connection strength between the cell 110 and the electrode 210 is determined as being weak, the intracellular signal measurement device 130 may increase the intensity of the current applied to the cell 110. However, in order to prevent the cell 110 from being destroyed, the intensity of the current may not be increased indefinitely, and may only be increased up to the upper limit (e.g., set by the user or set by the intracellular signal measurement device 130).

FIG. 6 is a diagram illustrating an electronic device according to one or more embodiments.

Referring to FIG. 6, an electronic device 600 may include a memory 610 and a processor 630. The electronic device 600 may include the intracellular signal measurement device 130 of FIG. 1A.

The memory 610 may store instructions (or programs) executable by the processor 630. For example, the instructions may include instructions for performing an operation of the processor 630 and/or an operation of each component of the processor 630.

The memory 610 may be implemented as a volatile memory device or a non-volatile memory device.

The volatile memory device may be implemented as a dynamic random access memory (RAM) (DRAM), a static random access memory (SRAM), a thyristor RAM (T-RAM), a zero capacitor RAM (Z-RAM), or a twin transistor RAM (TTRAM).

The non-volatile memory device may be implemented as an electrically erasable programmable read-only memory (EEPROM), a flash memory, a magnetic random-access memory (MRAM), a spin-transfer torque (STT)-MRAM, a conductive bridging RAM (CBRAM), a ferroelectric RAM (FeRAM), a phase change RAM (PRAM), a resistive RAM (RRAM), a nanotube RRAM, a polymer RAM (PoRAM), a nano floating gate memory (NFGM), a holographic memory, a molecular electronic memory device, and/or an insulator resistance change memory.

The processor 630 may process data stored in the memory 610. The processor 630 may execute computer-readable codes (e.g., software) stored in the memory 610, and instructions triggered by the processor 630.

The processor 630 may be a hardware-implemented data processing device having a circuit that is physically structured to execute desired operations. The desired operations may include, for example, code or instructions included in a program.

The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The processor 630 may cause the electronic device 600 to perform one or more operations by executing the instructions and/or code stored in the memory 610. Operations performed by the electronic device 600 may be substantially the same as the operations performed by the intracellular signal measurement device 130 described with reference to FIGS. 1A to 5. Accordingly, a repeated description thereof is omitted.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), RAM, flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

Each of the embodiments provided in the above description is not excluded from being associated with one or more features of another example or another embodiment also provided herein or not provided herein but consistent with the disclosure.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An electronic device comprising:
an electrode configured to contact a cell;
a power supply device connected to the electrode and configured to apply a current to the cell;
an amplifier circuit configured to measure at least one component of the current;
a processor; and
a memory storing instructions,
wherein the instructions, when executed by the processor, cause the electronic device to:
measure an impedance between the cell and the electrode based on the current, and
determine a connection strength between the cell and the electrode based on the impedance.

2. The electronic device of claim 1, wherein the power supply device comprises a first power supply device configured to apply a direct current (DC) to the cell and a second power supply device configured to apply an alternating current (AC) to the cell.

3. The electronic device of claim 2, wherein the at least one component of the current comprises a DC component and an AC component, and
wherein the amplifier circuit comprises a first amplifier circuit configured to measure the DC component of the current and a second amplifier circuit configured to measure the AC component of the current.

4. The electronic device of claim 3, wherein the instructions, when executed by the processor, further cause the electronic device to measure, through the first amplifier circuit, a DC voltage of the electrode generated by the DC applied by the first power supply device to the cell; and
wherein the instructions, when executed by the processor, cause the electronic device to measure the impedance by measuring, based on the measured DC voltage, a first impedance of the DC component generated by applying the DC to the cell.

5. The electronic device of claim 4, wherein the instructions, when executed by the processor, further cause the electronic device to measure, through the second amplifier circuit, the AC applied by the second power supply device to the cell; and
wherein the instructions, when executed by the processor, cause the electronic device to measure the impedance by measuring, based on the measured AC, a second impedance of the AC component generated by applying the AC.

6. The electronic device of claim 1, wherein the instructions, when executed by the processor, cause the electronic device to determine the connection strength by:
based on the impedance being greater than a preset threshold value, determining that the connection strength between the cell and the electrode is strong, and
based on the impedance is smaller than the preset threshold value, determining that the connection strength between the cell and the electrode is weak; and
wherein the instructions, when executed by the processor, further cause the electronic device to increase an intensity of the current applied to the cell based on the connection strength being determined to be weak.

7. The electronic device of claim 1, wherein the instructions, when executed by the processor, further cause the electronic device to adjust an intensity of the current based on the connection strength between the cell and the electrode.

8. The electronic device of claim 7, wherein the instructions, when executed by the processor, cause the electronic device to adjust the intensity of the current by increasing the intensity of the current based on the connection strength between the cell and the electrode being determined to be weak.

9. A method of operating an electronic device, the method comprising:
applying at least one component of a current to a cell that contacts an electrode;
measuring an impedance between the cell and the electrode based on the current; and
determining a connection strength between the cell and the electrode based on the impedance.

10. The method of claim 9, wherein the at least one component of the current comprises a direct current (DC) component and an alternating current (AC) component.

11. The method of claim 10, wherein the measuring of the impedance between the cell and the electrode comprises measuring at least one of the DC component and the AC component.

12. The method of claim 11, wherein the measuring of the impedance between the cell and the electrode further comprises:
measuring a DC voltage of the electrode generated by a DC applied to the cell; and
measuring, based on the measured DC voltage, a first impedance of the DC component generated by applying the DC to the cell.

13. The method of claim 12, wherein the measuring of the impedance between the cell and the electrode further comprises:
measuring an AC applied to the cell; and
measuring, based on the measured AC, a second impedance of the AC component generated by applying the AC to the cell.

14. The method of claim 9, wherein the determining of the connection strength between the cell and the electrode comprises:
based on the impedance being greater than a preset threshold value, determining that the connection strength between the cell and the electrode is strong, and
based on the impedance being smaller than the preset threshold value, determining that the connection strength between the cell and the electrode is weak, and
wherein the method further comprises increasing an intensity of the current applied to the cell based on the connection strength being determined to be weak.

15. The method of claim 9, further comprising:
adjusting an intensity of the current based on the connection strength between the cell and the electrode.

16. The method of claim 15, wherein the adjusting of the intensity of the current comprises increasing the intensity of the current based on the connection strength between the cell and the electrode being determined to be weak.

17. A non-transitory, computer-readable storage medium storing instructions that, when executed by at least one processor, cause an intracellular signal measurement device to:
apply at least one component of a current to a cell that contacts an electrode;
measure an impedance between the cell and the electrode based on the current;
determine a connection strength between the cell and the electrode based on the impedance; and
increase an intensity of the current applied to the cell based on the connection strength being determined to be weak.

18. The storage medium of claim 17, wherein the at least one component of the current comprises a direct current (DC) component and an alternating current (AC) component, and
wherein the instructions, when executed by the at least one processor, cause the intracellular signal measurement device to measure the impedance between the cell and the electrode by measuring at least one of the DC component and the AC component.

19. The storage medium of claim 18, wherein the instructions, when executed by the at least one processor, cause the intracellular signal measurement device to measure the impedance between the cell and the electrode by:
measuring a DC voltage of the electrode generated by a DC applied to the cell; and
measuring, based on the measured DC voltage, a first impedance of the DC component generated by applying the DC to the cell.

20. The storage medium of claim 19, wherein the instructions, when executed by the at least one processor, cause the intracellular signal measurement device to measure the impedance between the cell and the electrode by:
measuring an AC applied to the cell; and
measuring, based on the measured AC, a second impedance of the AC component generated by applying the AC to the cell.
